(19) United States
(12) Patent Application Publication
(10) Pub. No.: US 2011/0026186 A1
(43) Pub. Date: Feb. 3, 2011

(54) ELECTROSTATIC DISCHARGE PROTECTION COMPONENT AND METHOD FOR MANUFACTURING THE SAME

(75) Inventors: Hidenori Katsumura, Hyogo (JP); Tatsuya Inoue, Osaka (JP); Hideaki Tokunaga, Osaka (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/934,747

(22) PCT Filed: Jun. 5, 2009
(86) PCT No.: PCT/JP2009/002543

§ 371 Date: Sep. 27, 2010

(30) Foreign Application Priority Data
Jun. 12, 2008 (JP) 2008-153826

(51) Int. Cl. H05F 3/00; B32B 37/12; B32B 37/14

(52) U.S. Cl. 361/212; 156/327

(57) ABSTRACT

An electrostatic discharge protection component includes an element body, a pair of discharge electrodes, and a pair of terminal electrodes. The element body includes a closed cavity therein. The discharge electrodes are formed in the element body in such a manner as to be exposed to the cavity. The terminal electrodes are connected to the discharge electrodes, respectively, and provided on the element body. There is an oxide of at least one metal selected from zinc, niobium, aluminum, magnesium, calcium, sodium, and potassium attached to the surface of at least one of the discharge electrodes in the cavity.

### TECHNICAL FIELD

The present invention relates to electrostatic discharge protection components, and more particularly, to an electrostatic discharge protection component for absorbing static electricity entering the signal wiring, and a method for manufacturing the component.

### BACKGROUND ART

To meet the demand for more compact and more sophisticated electronic devices in recent years, integrated circuit chips (ICs) are becoming increasingly microfabricated and highly integrated. The ICs, however, are having a decrease in withstand voltage, and therefore may be broken or have malfunction only by a small surge such as an electrostatic discharge surge occurring e.g. from contact between the human body and a terminal of an electronic device.

One countermeasure is to provide an electrostatic discharge protection component between the wiring where static electricity enters and the ground so as to bypass the static electricity, thereby reducing the high voltage applied to the IC. Electrostatic discharge protection components have a high resistance and do not conduct electricity under normal conditions, but reduce their resistance and become able to conduct electricity when subjected to a high voltage signal such as static electricity. Well-known examples of electrostatic discharge protection components having this property include Zener diodes, multilayer chip varistors, and gap discharge devices.

A gap discharge device as a conventional electrostatic discharge protection component includes an element body having a cavity therein, a pair of discharge electrodes facing each other with the cavity therebetween, and terminal electrodes connected to the respective discharge electrodes. Under normal conditions, the discharge electrodes are opened (insulated from each other), but when a high voltage current such as static electricity enters the device, a discharge occurs in the cavity and current flows.

In such a gap discharge device, the discharge electrodes face each other usually with a gap of several tens of micrometers in which the entered static electricity is discharged. Examples of this type of gap discharge device are disclosed in Patent Literature 1 and 2.

Gap discharge devices have a radically smaller parasitic capacitance than Zener diodes and multilayer chip varistors. A large parasitic capacitance causes degradation of the signal quality of a circuit processing high-speed signals. For this reason, it is preferable for electrostatic discharge protection components to have a low parasitic capacitance, and therefore, gap discharge devices are advantageous in this respect. In addition, the cavity is filled with a gas to prevent the discharged area from being broken when high-voltage static electricity is applied.

When low-voltage static electricity is applied, on the other hand, a discharge is unlikely to occur in the cavity, possibly making it impossible to achieve the effect of reducing static electricity in leading-edge ICs and other devices insufficiently resistant to static electricity. The ease of the occurrence of discharge between the discharge electrodes facing each other in the cavity is largely due to the material of the discharge electrodes. More specifically, the lower the work function of the material of the discharge electrodes, the easier for a discharge to occur. The work function is the minimum energy needed to remove an electron from the surface of a material to a point at infinite distance away outside the surface. Well-known examples of materials having a low work function include zinc, niobium, aluminum, magnesium, calcium, sodium, and potassium. Most of these metals, however, have a high degree of activity, and therefore, it is difficult to actually use them as the material for discharge electrodes. The oxides of these metals also have a low work function, but most of them are electrically insulating materials having a high electric resistance, and hence cannot be used as discharge electrodes.

Furthermore, it is required to take countermeasures against static electricity that is applied more frequently with a higher voltage than before. In the case of the conventional gap discharge devices, the application of high-voltage static electricity a number of times in succession causes a short circuit between discharge electrodes. This is because the repeated application of high-voltage static electricity causes the discharge electrodes to melt or to peel off of the element body and then to come into contact with the opposite discharge electrodes. Electrostatic discharge may generate a temperature not less than 2500° C. instantaneously, and this is considered to be the cause of the melting of the discharge electrodes.

### Citation List

Patent Literature

Patent Literature 1: Japanese Patent Unexamined Publication No. H01-102884
Patent Literature 2: Japanese Patent Unexamined Publication No. H11-265808

### SUMMARY OF THE INVENTION

The present invention provides a high-performance and highly reliable electrostatic discharge protection component which can respond to low-voltage static electricity, have a high effect of reducing static electricity, and is free from short circuit even when high-voltage static electricity is repeatedly applied thereto.

The electrostatic discharge protection component of the present invention includes an element body, a pair of discharge electrodes, and a pair of terminal electrodes. The element body includes a closed cavity therein. The discharge electrodes are formed in the element body in such a manner as to be exposed to the cavity. The terminal electrodes are connected to the discharge electrodes, respectively, and provided on the element body. There is an oxide of at least one metal selected from zinc, niobium, aluminum, magnesium, calcium, sodium, and potassium attached to the surface of at least one of the discharge electrodes in the cavity.

These metal oxides have high insulating properties in spite of their low work function, thereby responding to low-voltage static electricity, having a high effect of reducing static electricity, and being free from short circuit even when high-voltage static electricity is repeatedly applied thereto.

The method of the present invention for manufacturing an electrostatic discharge protection component is carried out as follows. First, a first metal layer is formed on a first green sheet made of an insulating material. Then, a resin paste layer is formed on the first metal layer. The resin paste layer contains a resin component and an oxide of at least one metal selected from zinc, niobium, aluminum, magnesium, calcium, sodium, and potassium. Next, a second metal layer is formed on the resin paste layer. Then, a second green sheet made of an insulating material is laminated on the first green sheet in such a manner as to cover a laminate of the first and second metal layers with the resin paste layer interposed therebetween. Finally, the laminate of the first and second metal layers with the resin paste layer interposed therebetween and the first and second green sheets is sintered integrally, thereby evaporating the resin component of the resin paste layer. As a result, an element body having a closed cavity is completed.

An alternative method of the present invention for manufacturing an electrostatic discharge protection component is carried out as follows. First, a first metal layer and a second metal layer are formed on the first green sheet, so that these metal layers face each other with a predetermined spacing therebetween. Next, a resin paste layer is formed on the first and second metal layers. The resin paste layer contains the above-mentioned metal oxide and a resin component. Hereinafter, the same processes as in the former method are performed to complete an element body having a closed cavity.

According to the above-described two methods, the attachment of the metal oxide to the discharge electrodes and the formation of the cavity can be performed at the same time, thereby eliminating the separate step of attaching the metal oxide to the discharge electrodes.

### BRIEF DESCRIPTION OF THE DRAWINGS

FIG. 1 is a sectional view of an electrostatic discharge protection component according to a first exemplary embodiment of the present invention.

FIG. 2 is a diagram showing how a static electricity test is performed.

FIG. 3 is a graph showing the relation between an electrostatic voltage input and a static electricity reduction peak voltage.

FIG. 4A is a sectional view showing a step of a method for manufacturing an electrostatic discharge protection component according to the first exemplary embodiment of the present invention.

FIG. 4B is a sectional view showing a step subsequent to the step shown in FIG. 4A of the method for manufacturing an electrostatic discharge protection component according to the first exemplary embodiment of the present invention.

FIG. 4C is a sectional view showing a step subsequent to the step shown in FIG. 4B of the method for manufacturing an electrostatic discharge protection component according to the first exemplary embodiment of the present invention.

FIG. 4D is a sectional view showing a step subsequent to the step shown in FIG. 4C of the method for manufacturing an electrostatic discharge protection component according to the first exemplary embodiment of the present invention.

FIG. 4E is a sectional view showing a step subsequent to the step shown in FIG. 4D of the method for manufacturing an electrostatic discharge protection component according to the first exemplary embodiment of the present invention.

FIG. 4F is a sectional view showing a step subsequent to the step shown in FIG. 4E of the method for manufacturing an electrostatic discharge protection component according to the first exemplary embodiment of the present invention.

FIG. 4G is a sectional view showing a step subsequent to the step shown in FIG. 4F of the method for manufacturing an electrostatic discharge protection component according to the first exemplary embodiment of the present invention.

FIG. 5 is a sectional view of an electrostatic discharge protection component according to a second exemplary embodiment of the present invention.

### DETAILED DESCRIPTION OF PREFERRED EMBODIMENTS

### First Exemplary Embodiment

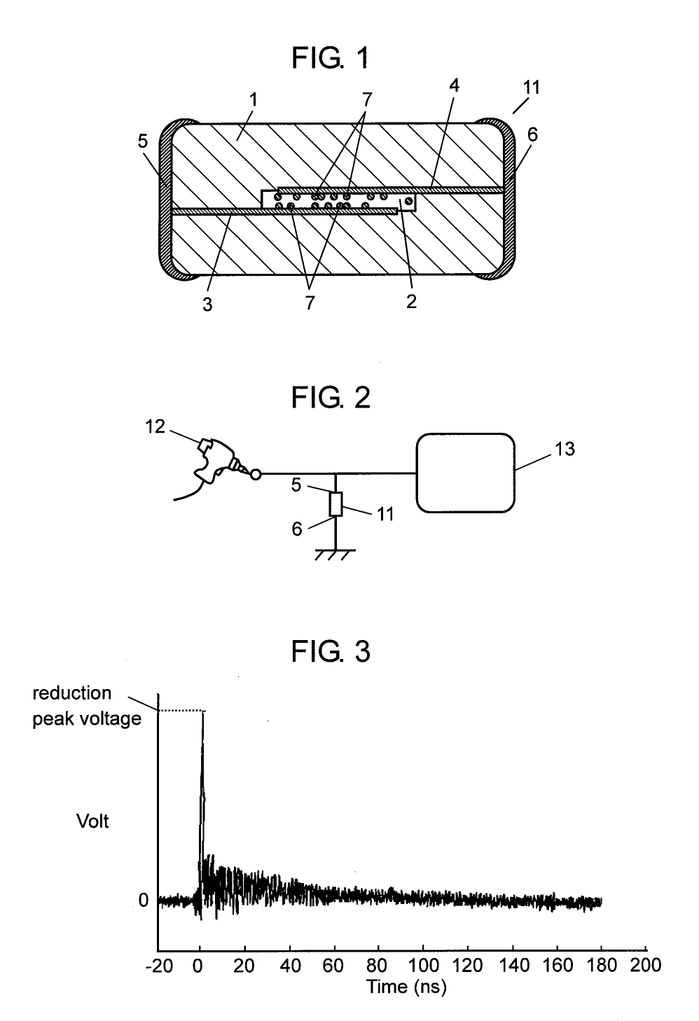

FIG. 1 is a sectional view of an electrostatic discharge protection component according to a first exemplary embodiment of the present invention. Electrostatic discharge protection component 11 includes element body 1, a pair of discharge electrodes 3 and 4, and terminal electrodes 5 and 6. Element body 1 includes closed cavity 2, which is embedded therein. Discharge electrodes 3 and 4 are formed in element body 1 in such a manner as to be exposed to cavity 2. More specifically, discharge electrodes 3 and 4 face each other with a predetermined spacing therebetween in cavity 2. Terminal electrodes 5 and 6 are connected to discharge electrodes 3 and 4, respectively, and provided on element body 1.

Element body 1 is preferably made of an insulating material containing as the main component of at least one ceramic composition selected from alumina, forsterite, steatite, mullite, and cordierite. electrostatic discharge protection component.

To make this phenomenon clearly understood, the way of estimation of the electrostatic discharge protection component is described as follows. FIG. 2 is a diagram showing how a static electricity test is performed. Electrostatic discharge gun 12 is connected to terminal electrode 5 of component 11, and terminal electrode 6 is grounded. Gun 12 sends a simulated waveform of static electricity (compliant with the IEC-6100-4-2 standard) to component 11. The electrostatic waveform is observed by digital oscilloscope 13.

The observed electrostatic waveform is the waveform of the static electricity not discharged in component 11. The lower the voltage is, the higher the performance of component 11 is. FIG. 3 is a graph showing the relation between an electrostatic voltage input and a static electricity reduction peak voltage. Generally, a high voltage peak appears in the initial stages, and then the voltage attenuates suddenly. The high voltage peak is considered to cause failure or malfunction of the device. This voltage is referred to as a reduction peak voltage, and is measured as the amplitude with respect to an input electrostatic voltage.

In the structure shown in FIG. 1, in the case where oxide 7 is not attached and when the input electrostatic voltage is not more than 5 kV, the observed electrostatic waveform becomes the same as the simulated waveform of static electricity that component 11 has received. In other words, the component does not generate a discharge, which means that it does not fulfill its function. When the input electrostatic voltage is 6 kV or more, the waveform shown in FIG. 3 is observed. However, the reduction peak voltage is high; for example, when the input electrostatic voltage is 8 kV, the reduction peak voltage is as high as 800 to 1000V.

On the other hand, in the case where mayenite powder (12CaO-7Al₂O₃; average particle size: about 0.5 μm) is attached as oxide 7 to discharge electrodes 3 and 4, the electrostatic discharge protection component operates when the input electrostatic voltage is 2 kV or more. In addition, the reduction peak voltage at 8 kV is as low as 250 to 350V. Mayenite powder, which is also called “C12A7” by its compositional formula, is a material having a unique nanocrystalline structure and a nano-sized cage with an inner diameter of 0.4 nm. As a result, mayenite powder has a low work function of less than 3 eV, which is specifically low as an oxide, thereby exhibiting the above-described excellent properties as the most preferable oxide 7 to be attached to discharge electrodes 3 and 4.

In the case of using aluminum oxide powder (average particle size: 0.2 μm) or magnesium oxide powder (average particle size: 0.4 μm) as oxide 7, component 11 exhibits more excellent properties than in the case of not using oxide 7. These oxides are preferably used as oxide 7 because of their stability, inexpensiveness, and ready availability. They have, however, a higher work function than mayenite powder, so that the starting voltage is about 4 kV, and the reduction peak voltage is 400 to 600V when the input electrostatic voltage is 8 kV.

Next, an electrostatic voltage of 25 kV is applied 250 times in succession, and then the insulation resistance value of the electrostatic discharge protection component is measured before and after the repeated test. In the case where oxide 7 is not used, none of the 100 test samples are completely short-circuited, but about 10% of them have a decrease in their insulation resistance values to the order of 106 The insulating material has a small specific dielectric constant of not more than 15, thereby having a low parasitic capacitance.

Discharge electrodes 3, 4, and terminal electrodes 5, 6 are made, for example, of a metal mainly composed of tungsten. High-melting point metals such as tungsten are preferable materials for discharge electrodes 3 and 4 in order to withstand high temperature during electrostatic discharge. Discharge electrodes 3, 4 and terminal electrodes 5, 6 are preferably made of the same metal, or metals capable of forming an alloy so as to ensure their bonding strength to resist the impact of static electricity when it enters the component. However, the material of the electrodes is not limited to tungsten. These metals may be made of molybdenum instead of tungsten, or made of an alloy which is mainly composed of at least one of tungsten and molybdenum, and has a melting point not less than 2600° C.

Discharge electrodes 3 and 4 have oxide 7 of a metal attached to their surfaces. Alternatively, only one of discharge electrodes 3 and 4 may have oxide 7 attached to its surface. Oxide 7 is an oxide of at least one metal selected from zinc, niobium, aluminum, magnesium, calcium, sodium, and potassium. Oxide 7 of these metals has a low work function. Most of the oxides have a work function of not more than 4.5 eV, thereby accelerating electrostatic discharge between discharge electrodes 3 and 4. Oxide 7 releases electrons in response to static electricity having a voltage that is too low to cause a discharge without the attachment of oxide 7, thereby generating a discharge between discharge electrodes 3 and 4. The attachment of oxide 7 also increases the number of electrons released during discharge, thereby increasing the amount of electrostatic discharge current between discharge electrodes 3 and 4. This improves the performance of the Ω. On the other hand, in the case where mayenite powder, aluminum oxide powder, or magnesium oxide powder is attached on the discharge electrodes, the insulation resistance values of all the test samples remain at not less than 1010 Ω, showing no decrease after the repeated test. The reason for this is considered that these oxides are usually stable and have high insulation resistance, thereby playing a role in preventing a short circuit between discharge electrodes 3 and 4. Oxide 7 with this role is preferably attached to and covers the entire surfaces of discharge electrodes 3 and 4 in cavity 2 so that it can completely prevent the occurrence of a short circuit.

In the present exemplary embodiment, the most preferable example of the oxide is mayenite powder, and the second most preferable examples are aluminum oxide powder and magnesium oxide powder. In addition, a metal oxide of at least one metal selected from zinc oxide, niobium oxide, calcium oxide, sodium oxide, and potassium oxide has a low work function. In addition to these oxides, their composite oxides, and their mixtures can also be used as oxide 7. Thus, an oxide of at least one metal selected from zinc, niobium, aluminum, magnesium, calcium, sodium, and potassium can be used as oxide 7 because of its stability and high insulation resistance.

In the case where oxide 7 is attached to the surface of only one of discharge electrodes 3 and 4, it is preferable to show to which of terminal electrodes 5 and 6 the discharge electrode having oxide 7 attached thereto is connected. Since static electricity is direct current, the effect of oxide 7 can be obtained by connecting the ground such as a human body that is the origin of discharge to the terminal electrode connected to the discharge electrode having oxide 7 attached thereto. Thus, in the case where oxide 7 is attached to the surface of only either one of discharge electrodes 3 and 4, it is necessary to consider the direction in which they are connected when used.

In the case where oxide 7 is attached to only either one of discharge electrodes 3 and 4, for example, only to discharge electrode 3, oxide 7 preferably covers the entire surface of the portion of discharge electrode 3 that is exposed to cavity 2 in order to prevent the occurrence of a short circuit when static electricity is applied a number of times in succession.

The average particle size of oxide 7 is preferably as small as possible in terms of making the most of the surface area, and preferably has a predetermined size in terms of being dispersed without agglomeration due to the surface potential. As a result, the preferable average particle size of oxide 7 is in the submicron range (0.1 μm or more and less than 1 μm).

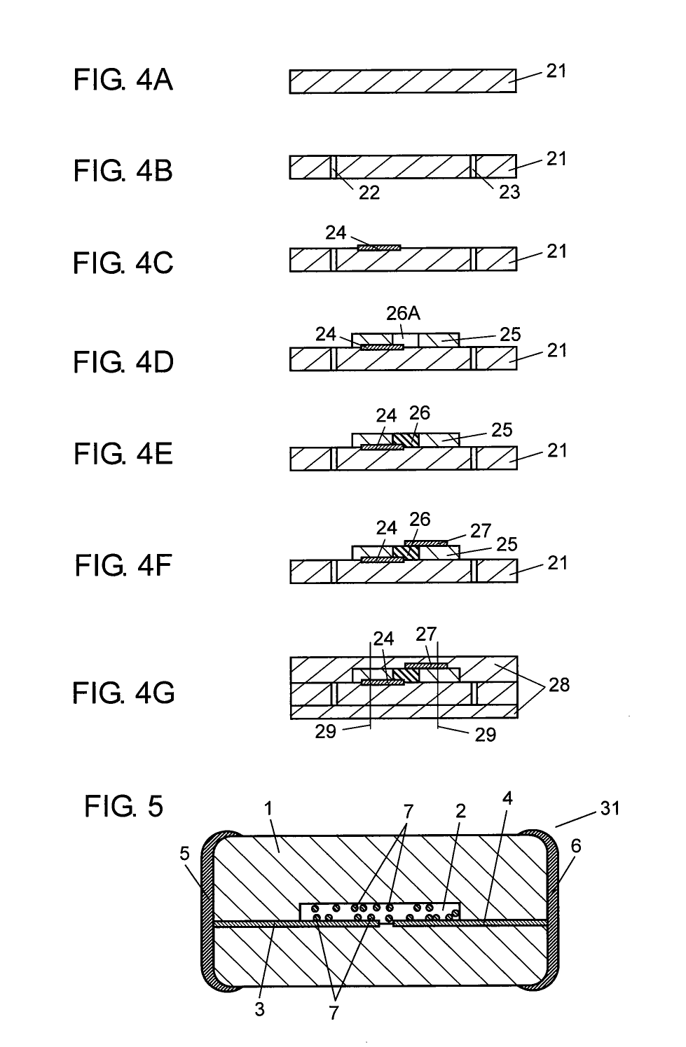

Hereinafter, a method for manufacturing electrostatic discharge protection component 11 will be described with reference to FIGS. 1, and 4A to 4G. FIGS. 4A to 4G are sectional views showing steps of the method for manufacturing an electrostatic discharge protection component. In the following description, element body 1 is made of forsterite, and discharge electrodes 3 and 4 are made of tungsten. Note that other materials than these may be used within the scope of the present invention.

First, slurry is prepared by adding acrylic resin and a plasticizer to forsterite powder having an average particle size of about 2 μm, and then adding a solvent such as toluene thereto. The slurry is formed into green sheet (first green sheet) 21 having a thickness of about 100 μm shown in FIG. 4A using a doctor blade method. Then, as shown in FIG. 4B, green sheet 21 is perforated with 200 μm-diameter through-holes 22 and 23 using a mold or other devices. Through-holes 22 and 23 are used as datum holes in all the subsequent printing steps.

Next, a paste for printing is prepared from tungsten powder having an average particle size of 1 μm. This paste is formed into pattern (first metal layer) 24 by screen printing on green sheet 21, using through-holes 22 and 23 as datum holes as shown in FIG. 4C. Pattern 24 becomes discharge electrode 3.

Next, another paste for printing is prepared from the same forsterite powder as used for green sheet 21. This paste is formed into cavity wall layer 25 on green sheet 21 and pattern 24 as shown in FIG. 4D by screen printing. Cavity wall layer 25 is a pattern having cavity forming part 26A as a hollow shape.

Next, a resin paste is prepared by mixing and kneading together acrylic beads each having a diameter of about 3 μm, acrylic resin as a resin component, and oxide 7 (e.g. mayenite powder) to be attached to discharge electrodes 3 and 4. As shown in FIG. 4E, the resin paste is injected into cavity forming part 26A surrounded by cavity wall layer 25 by screen printing so as to form resin paste layer 26.

Acrylic resin is preferable because it can be decomposed more easily than other resins at low temperatures and therefore unlikely to cause damage around cavity forming part 26A after sintering. Alternatively, the acrylic resin can be replaced by other resins that are decomposed easily at low temperatures. The acrylic beads are added to prevent deformation of cavity forming part 26A in the subsequent pressing step. For this reason, it is preferable to add acrylic beads to the resin paste.

The laminate thus prepared is pressed to level its surface. Then, as shown in FIG. 4F, pattern (second metal layer) 27 is formed by screen printing so that patterns 24 and 27 face each other with horizontal displacement. At least part of pattern 27 is located on resin paste layer 26.

Next, in order to ensure the thickness of the component, as shown in FIG. 4G, a plurality of invalid layer green sheets (second green sheets) 28 are laminated on and under the laminate. Invalid layer green sheets 28, which is made of an insulating material, is laminated at least on green sheet 21 so as to cover patterns 24 and 27 having resin paste layer 26 disposed therebetween. The resulting green sheet laminated body is cut along cutting lines 29 with a cutter.

The portion between cutting lines 29 is heat-treated at 200 to 300° C. to scatter the resin component away, and is subjected to integral sintering at 1250° C. in a nitrogen atmosphere. As a result of the heat treatment, the acrylic beads and the resin component contained in resin paste layer 26 are scattered away so that cavity forming part 26A becomes cavity 2 shown in FIG. 1, and patterns 24 and 27 become discharge electrodes 3 and 4. Cavity 2 thus formed has a height of 20 to 50 μm. Green sheet 21, cavity wall layer 25, and invalid layer green sheets 28 are integrated into element body 1. Thus, patterns 24 and 27 with resin paste layer 26 interposed therebetween, green sheet 21, and invalid layer green sheets 28 are integrally sintered to evaporate the resin component of resin paste layer 26. As a result, element body 1 having closed cavity 2 is completed.

In this case, only oxide 7 remains in cavity 2. In other words, after the sintering, oxide 7 is attached to the surfaces of the portions of discharge electrodes 3 and 4 that are exposed to cavity 2, and to the walls of cavity 2 as shown in FIG. 1.

Finally, terminal electrodes (not shown in FIG. 4A-4G) to be connected to discharge electrodes 3 and 4 are formed by, for example, applying silver paste to the side surfaces of element body 1 on which discharge electrodes 3 and 4 are exposed. As a result, electrostatic discharge protection component 11 shown in FIG. 1 is completed.

The green sheet laminated body shown in FIG. 4G may include a plurality of parts between through-holes 22 and 23, and the parts are cut apart from each other along a plurality of units of cutting lines 29. Thus, non-sintered pieces which become electrostatic discharge protection components 11 can be formed efficiently.

According to the above-described method, the attachment of oxide 7 to discharge electrodes 3, 4, and the formation of cavity 2 can be performed at the same time, thereby eliminating the separate step of attaching oxide 7 to discharge electrodes 3 and 4. It is also possible to adjust the amount of oxide 7 attached to discharge electrodes 3 and 4 in a simple and stable manner of changing the content of oxide 7 in the resin paste.

### Second Exemplary Embodiment

An electrostatic discharge protection component according to a second exemplary embodiment of the present invention will be described as follows with reference to FIG. 5. FIG. 5 is a sectional view of an electrostatic discharge protection component according to a second exemplary embodiment of the present invention. In FIG. 5, like elements are labeled with like reference numerals with respect to FIG. 1.

In electrostatic discharge protection component 31, discharge electrodes 3 and 4 face each other with a predetermined spacing therebetween on the bottom surface of cavity 2. Component 31 having this structure provides effects similar to component 11 of the first exemplary embodiment.

Component 31 can be manufactured also by the similar method as that shown in FIGS. 4A to 4G according to the first exemplary embodiment. Specifically, after pattern 24 is formed, pattern 27 is formed to face pattern 24 at a predetermined spacing therefrom and in the same plane. Then, cavity wall layer 25 is formed, a paste containing acrylic resin and oxide 7 is injected into cavity forming part 26A, and invalid layer green sheets 28 are laminated thereon. Hereafter, the method proceeds in the same manner as in the first exemplary embodiment.

Electrostatic discharge protection component 31 has a smaller area in which discharge electrodes 3 and 4 face each other, and is therefore less resistant to the repeated application of high-voltage static electricity than component 11. On the other hand, component 31 has a smaller parasitic capacitance than component 11, thereby being suitable for circuits that process higher frequency signals.

Meanwhile, element body 1 is made of a single component and surrounds cavity 2 in the first and second exemplary embodiments, but may alternatively be composed of a plurality of components made of the same material. These components may alternatively be made of different materials from each other.

Terminal electrodes 5 and 6 are formed on side surfaces (end faces) of element body 1 as shown in FIGS. 1 and 5, but the present invention is not limited to this structure. The shape and other conditions of terminal electrodes 5 and 6 are not limited as long as they are connected to discharge electrodes 3 and 4, respectively, and are provided on element body 1.

### INDUSTRIAL APPLICABILITY

As described above, the electrostatic discharge protection component according to the present invention can respond to low-voltage static electricity, have a high effect of reducing static electricity, and is free from short circuit even when high-voltage static electricity repeatedly applied thereto. Therefore, this high-performance and highly reliable component can be applied widely to various devices that are required to take countermeasures against static electricity.

1. An electrostatic discharge protection component comprising:
an element body including a closed cavity therein;
a pair of discharge electrodes formed in the element body in such a manner as to be exposed to the cavity; and
a pair of terminal electrodes connected to the pair of discharge electrodes, respectively, and provided on the element body,
wherein an oxide of at least one metal selected from zinc, niobium, aluminum, magnesium, calcium, sodium, and potassium is attached to a surface of at least one of the discharge electrodes in the cavity.

2. The electrostatic discharge protection component according to claim 1,
wherein the oxide is 12CaO-7Al₂O₃.

3. The electrostatic discharge protection component according to claim 1,
wherein the oxide is at least one of aluminum oxide and magnesium oxide.

4. The electrostatic discharge protection component according to claim 1,
wherein the oxide attaches to and covers entire surfaces of the discharge electrodes in the cavity.

5. The electrostatic discharge protection component according to claim 1,
wherein the element body is an insulating body containing at least one ceramic composition selected from alumina, forsterite, steatite, mullite, and cordierite.

6. A method for manufacturing an electrostatic discharge protection component, the method comprising:
forming a first metal layer on a first green sheet made of an insulating material;
forming a resin paste layer on the first metal layer, the resin paste layer containing a resin component and an oxide of at least one metal selected from zinc, niobium, aluminum, magnesium, calcium, sodium, and potassium;
forming a second metal layer on the resin paste layer;
laminating a second green sheet made of an insulating material on the first green sheet in such a manner as to cover a laminate of the first and second metal layers with the resin paste layer interposed therebetween; and
sintering the laminate of the first and second metal layers with the resin paste layer interposed therebetween integrally with the first and second green sheets so as to evaporate the resin component of the resin paste layer, thereby forming an element body including a closed cavity and a pair of discharge electrodes exposed to the cavity, and attaching the oxide of the metal to a surface of at least one of the discharge electrodes in the cavity.

7. A method for manufacturing an electrostatic discharge protection component, the method comprising:
forming a first metal layer and a second metal layer on a first green sheet made of an insulating material, the first metal layer and the second metal layer facing each other with a predetermined spacing therebetween;
forming a resin paste layer on the first metal layer and the second metal layer, the resin paste layer containing a resin component and an oxide of at least one metal selected of least from zinc, niobium, aluminum, magnesium, calcium, sodium, and potassium;
laminating a second green sheet made of an insulating material on the first green sheet in such a manner as to cover a laminate of the first and second metal layers with the resin paste layer interposed therebetween; and
sintering the laminate of the first and second metal layers with the resin paste layer interposed therebetween integrally with the first and second green sheets so as to evaporate the resin component of the resin paste layer, thereby forming an element body including a closed cavity and a pair of discharge electrodes exposed to the cavity, and attaching the oxide of the metal to a surface of at least one of the discharge electrodes in the cavity.
